(19) United States
(12) Patent Application Publication
(10) Pub. No.: US 2025/0135752 A1
(43) Pub. Date: May 1, 2025

(54) DECORATIVE ARTICLES AND METHOD FOR CREATING DECORATIVE ARTICLES

(71) Applicant: Micah Heimlich, Yucca Valley, CA (US)

(72) Inventor: Micah Heimlich, Yucca Valley, CA (US)

(21) Appl. No.: 18/934,004

(22) Filed: Oct. 31, 2024

Related U.S. Application Data
(60) Provisional application No. 63/546,592, filed on Oct. 31, 2023.

(51) Int. Cl. B32B 17/10; B05C 19/00; C03C 17/22

(52) U.S. Cl. CPC B32B 17/1044; B05C 19/00; B32B 17/10036; B32B 17/10935; C03C 17/22; B32B 2307/304; B32B 2451/00; C03C 2217/28; C03C 2218/17

(57) ABSTRACT

The present invention relates to a method for creating a glass article having increased thermal resistive qualities, the method includes encasing mica and/or other minerals in between at least two pieces of interlay film which is positioned between two pieces of glass and baking the glass in a vacuum sealed heater at a predetermined temperature for a predetermined time period. The method may also include positioning powder coating on a substrate, heating the substrate and powder coating to heat and melt the powder coating; and then positioning minerals on the substrate when the powder coating is hot, or optionally placing the powder coating over the minerals and heating the powder coating together with the minerals on the substrate. The invention also relates to the articles produced using the above processes.

### FIELD OF INVENTION

A method for decorating articles of the substrate using mica and other naturally occurring materials and minerals, gems, and semi-precious gems, glass, stone or ceramic, and optionally using powder coating, is provided that is similar to the visual effect created by sheets of glass, optical glass, mirror, Plexiglas® (which is registered trademark of Röhm GmbH), lucite, plastic, ceramic, marble, onyx, alabaster, granite or other occurring stone or minerals.

### BACKGROUND

Many people who are accustomed to working with materials such as mica often become frustrated with how delicate and unforgiving the material can be and struggle with maintaining its structure while using it in its natural state. Mica is a naturally formed mineral obtained through mining. It comes in a variety of earth tone colors like pink, rosy, purple, silver, and gray, these tones coming from lepidolite; blue tones coming from kyanite; dark green, brown, and black from biotite; yellowish-brown and green-white from phlogopite; and colorless or transparent from muscovite. It is mined as blocks and/or sheets of varying thickness and friability. Translucency and reflectivity are the chief characteristics of sheets of mica. The word mica is derived from the Latin word mica, meaning a crumb, and probably influenced by micare, to glitter.

Mica is traditionally used to add color and shimmer to projects such as epoxy resin, soap, candles, cosmetics, and even translucent polymer clay. This can be done by grinding the mica into a powder and combining it with an article of use, like resin or clay.

Mica minerals can be easily broken along their cleavage plane, so they can be picked apart into thin, flexible sheets. Mica minerals often form pseudohexagonal crystals, which means they exhibit a six-sided crystal habit without having a hexagonal crystal system (micas are monoclinic). Further, mica also exhibits chatoyance, or an undulating luster.

Given the delicate nature of mica, working with mica in sheets or blocks (also called books of mica) can be tricky if you are trying to achieve a certain look, the material easily breaks and crumbles, and can have a hard time adhering to the surface of what you are creating. Thus, a need for the present invention exists to cleanly seal and display articles containing mica or other natural minerals and materials.

### SUMMARY

A method for decorating articles of substrate using mica and other naturally occurring materials is provided that is similar to the visual effect created by sheets of marble or other naturally occurring stone or minerals. In particular, the product offers novel gradations of reflectiveness or refractiveness in opacities extending from pearlescent to iridescent. It can be used for decorative purposes as wall mounts, in furniture or lights, windows, partitions, etc. It can be cut into a wide variety of shapes, or UV-bonded, bent, molded, or “slumped.”

In accordance with one example of an implementation of the invention, a method for creating a decorative display includes, positioning minerals on a substrate, coating the minerals with a powder coating; and baking the substrate with coated minerals. In another example, the method includes positioning powder coating on a substrate; heating the substrate and powder coating to heat and melt the powder coating; and positioning minerals on the substrate when the powder coating is hot.

In one example, this powder coating may be used to color the mica to create a colored stone effect. The powder coating may be of a type that is applied as a free-flowing, dry powder and then cured. The powder coated mica can also be laminated in glass. Using transparent powders on the mica creates a colored effect along with other optical qualities further in this application. For example, a transparent powder coating on transparent mica creates a translucent effect.

In both examples above, the minerals used may be mica and the methods further includes the step of positioning the minerals on the substrate by first separating a sheet of mica into individual panels of mica before positioning the separated mica on the substrate. The minerals may optionally be selenite crystals, or other semi-precious gems, agates, minerals, etc., and the substrate may be glass, mirror or ceramic filter paper. The powder coating may further be a translucent coating. The powder coating and substrate may be repeatedly heated and further mica may be added to the substrate between heating of the powder coating and the substrate. In all cases, the steps of applying the powder coating, applying the minerals and heating or applying the powder coating, heating and applying the minerals may be repeated.

In yet a further example, the mica is encased in glass without the use of powder coating. A method for creating a decorative display is provided that includes the steps of cutting a first and second piece of glass into a desired shape; positioning a first plastic optical interlay film on top of the first piece of glass; arranging mica on the first plastic optical interlay film; positioning a second plastic optical interlay film on top of the mica; placing the second piece of glass over the second plastic optical interlay film in a position opposing the mica to create a decorative assembly; baking the decorative assembly in a vacuum sealed heater at various temperatures ranging from 250-325° F. for 10-15 hours. The heating at various temperatures may include multitemperature steps with specific hold times. Further, the steps of positioning the mica and interlay may, in some applications, include numerous layers of mica and interlay. Additionally, there can be layers of glass, interlay and mica creating a thick multilayered glass block. Alternatively or additionally, gems and other semi-precious gems or agates may be crushed or made into tiny crystals or dust arranged on the mica on the interlay film at one or more layers of mica and interlay.

Using the methods set forth above, the final product may be a substrate having mica or other minerals embedded within a powder coating heated on the substrate, where the substrate may be glass, mirror or ceramic filter paper, to name a few examples. The layer of powder coating and mica may be single layered or include multiple layers of one or more powder coating or mica and/or other minerals. In another example, the final product is mica or other minerals positioned between two sheets of plastic optical interlay film, which are then positioned between two substrates, such as glass. Adding mica or muscovite to the glass also provides thermal insulation and/or solar heat gain, which could be advantageous in architectural applications for windows or skylights or similar applications where light diffusion or reflection is desirable.

In particular, using muscovite mica can provide unique properties to the glass. It has the highest dielectric strength of the various types of mica that may be used, in addition to a very high thermal resistance of close to 600 degrees Celsius. Thus, products made with muscovite can act as dielectric and thermal insulators, which may be useful for energy conservation of thermal heat transfer through glass that has some form of embedded or laminated mica encased in the glass.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

Other objectives and many of the attendant advantages of embodiments of the present disclosure will become readily perceived and better understood with reference to the following more detailed specification of embodiments in connection with the accompanying drawings. Features which are substantially or functionally the same or similar are designated by the same reference signs.

FIG. 1 is a flow diagram of one example method of the present invention.

FIG. 1A is another flow diagram of another example method in accordance with the present invention.

FIG. 2 is an illustration of a mica and interlay between two pieces of glass layers in accordance with one example of an implementation of the present invention.

FIG. 3 is an exploded view of one example of the mica encased glass of the present invention showing the various layers of the glass, similar to that shown in FIG. 2.

FIG. 4 is a flow diagram of another example method of the present invention.

FIG. 5 is an illustration of a mica and powder coating design on a substrate in accordance with the present invention.

FIG. 6 is an exploded view of one example of the mica and powder coating on a substrate, similar to that shown in FIG. 5.

### DETAILED DESCRIPTION OF THE INVENTION

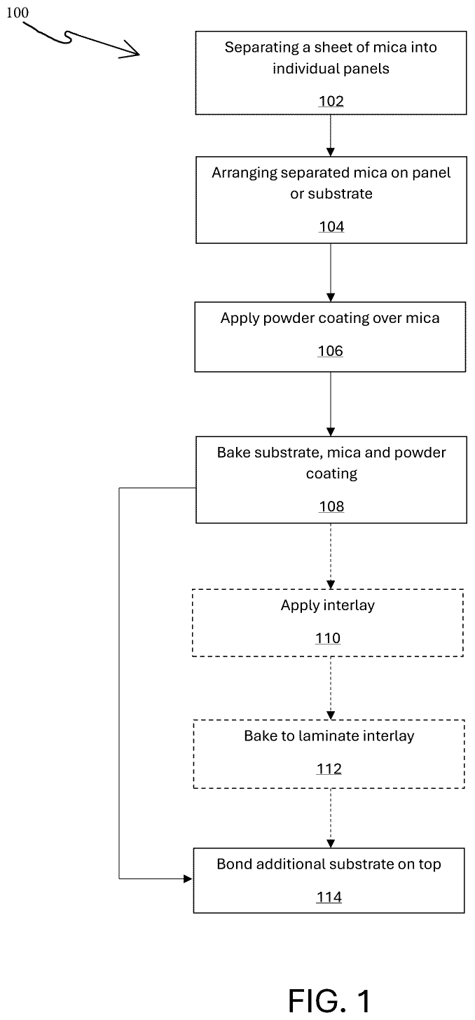

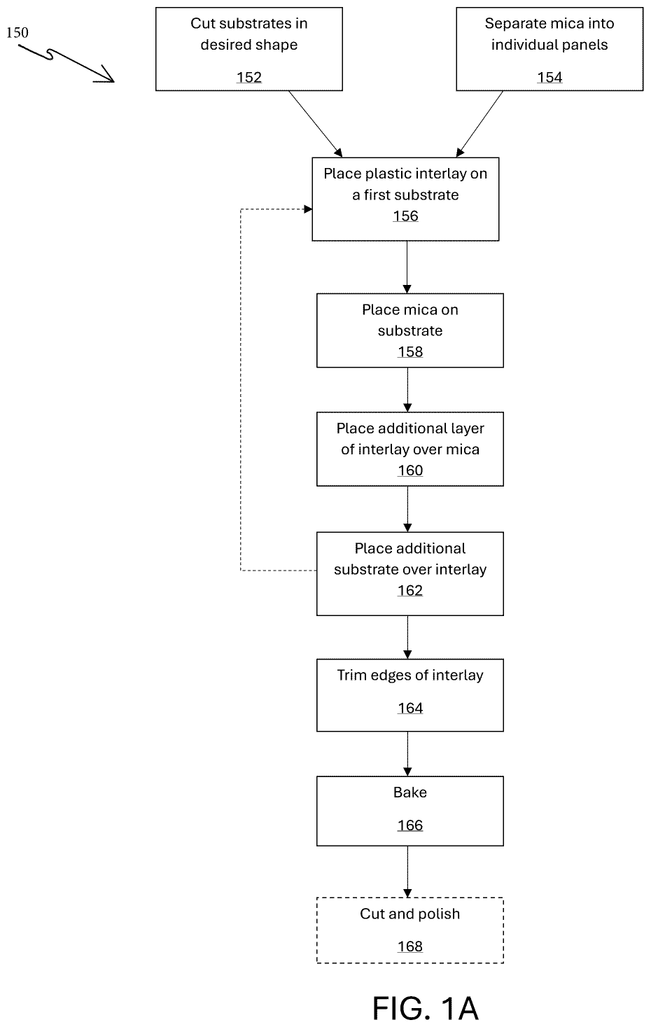

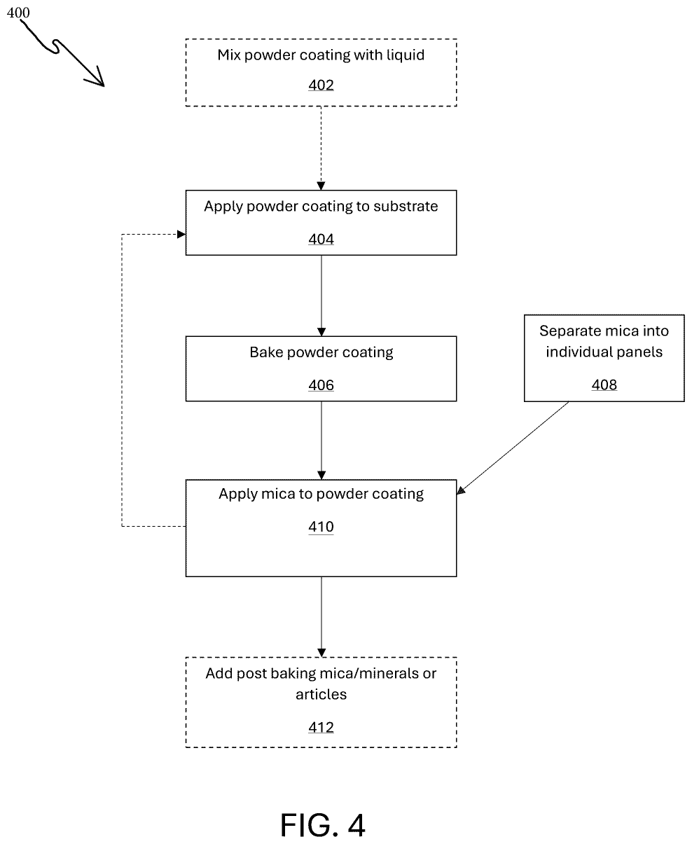

In accordance with FIGS. 1-3, the method of the present invention involves encasing mica or other naturally occurring materials between two substrates, such as glass panes, and in accordance with FIGS. 4-6 positioning such materials on another substrate, such as ceramic paper.

As shown in FIGS. 1-3, when encasing the mica or other naturally occurring materials between two substrates, the present method allows for the use of mica, for example, on articles in a manner that allows light to not only reflect off of the mica, but also pass through the mica to create a new and novel visual effect. While the visual effect is similar to that of a sheet of marble and other naturally occurring stone or minerals, the present invention allows for the mica or minerals to be displayed in a manner that allows the visual effect to change dramatically with different lighting effects (e.g., back lighting or light passing through or reflecting off the substrate).

In particular, the product offers novel gradations of reflectiveness or refractiveness in opacities extending from pearlescent to iridescent. It can be used for decorative purposes such as wall mounts, in furniture or lights, windows, partitions, etc. It can be cut into a wide variety of shapes, or UV-bonded, bent, molded, or “slumped.”

As shown in FIG. 1, when using mica as the mineral to create the mica encased glass 100, the method includes the first step 102 of separating or “clefting” a sheet of mica into individual panels of a fine but rigid quality. Once separated, any loose or partially delaminated mica flakes are moved from the sheets. Next, at step 104, the separated mica is arranged on a panel or flat surface, such as glass or a mirror, for example, a non-tempered, tempered or heat treated glass. The separated mica can be arranged using any known application method, including but not limited to, blending, brushstrokes, combing, dragging, spooning, shaking paper, piping, throwing, splashing, hand shaping, rippling, flicking, embossing/debossing, scraping, stenciling or simply placing the flakes on the substrate.

Then, at step 106, powder coating is applied to the substrate over the separated and placed mica. Powder coating may, for example, be powder coating sold under the brand name Prismatic Powders®. While a transparent powder coating may be used to allow the light to pass through, powder coatings come in a full range of colors and it may be desirable for certain applications to use colored powder coatings, including transparent and translucent coatings, metallic coatings, solid color coatings, or coating with other visual effects. The use of powder coating also improves the appearance of low-grade mica by masking natural impurities like water stains and other inclusions.

Next, at step 108, the substrate with the mica and powder coating is baked in an oven at approximately 400° F. for approximately 10 minutes, or at least 400° F. for at least 10 minutes. After baking, pressure can then optionally be applied to the surface to keep the mica with coating flat against the surface. Individual treated substrates can then be bonded together with other materials and surfaces. Additionally and optionally, multiple layers of the glass, mica and powder coats can be stacked, baked separately or baked together as a single unit.

Further (and optionally), at step 110, the powder coated mica can be laminated by adding an interlay film over the powder coated mica. At step 112, a second substrate may be placed over the powder coated mica and baked at a lower temperature to prevent the burning of the interlay film. For example, the interlay may be baked at or between 250-325° F. for several hours, as set forth further below. In all cases, an additional substrate (at step 114) may be bonded on top of the powder coated mica, with or without the interlay film.

The above process can be replicated using selenite crystals. A naturally occurring mineral. Selenite exhibits a unique chatoyance (or shimmering). Its crystalline structure also refracts light lengthwise. Selenite crystals can be used alone or in combination with mica or other minerals, Ulexite, gems, semiprecious gems, minerals, agates, crystals, both natural and man-made, as well as other similar or desire material to create differing visual effects. In all cases, colored panels of mica or selenite crystals (or both) can be created at desired tints, colors and brightness.

In another example of an implementation, a method 150 for embedding the mica in the glass is provided at FIG. 1A. As shown in FIG. 1A, substrates, such as glass, mirror, acrylic or Plexiglas may be cut to a desired shape and size for a particular application, such as a window, door panel, glass panel, light fixture, furniture, etc, at step 152. In this example, at step 154 (which may be interchangeable with step 152) the mica is also separated or clefted into individual panels of a fine but rigid quality. At step 156, prior to placing the mica or minerals on a first substrate (e.g., the glass or mirror, etc.), a first plastic optical interlay film is placed on the substrate. Then, at step 158, the mica or minerals are arranged on the substrate, on top of the interlay film, in desired patterns (organic or geometric). At step 160 an additional layer of interlay film is placed over the mica and then, at step 162, an additional substrate is placed on top of the second interlay film.

At step 164, the interlay is then trimmed off the edges of the glass, and the edges of the combined glass substrates are secured together, for example, by taping the edges of the glass together. At step 166, the glass assembly with the mica and interlay are then placed in a vacuum-sealed oven at approximately 300° F. (or at or between 250-325° F.) and left in the oven to bake at that temperature for approximately 12 hours (or at or between 10-15 hours). The assembly, once it is cooked, can be optionally cut and polished, at 168. Additionally and optionally, multiple layers of the glass, interlay, mica and powder coatings can be stacked and taped to be baked as a single unit, by repeating the steps 156-162 of the process described above.

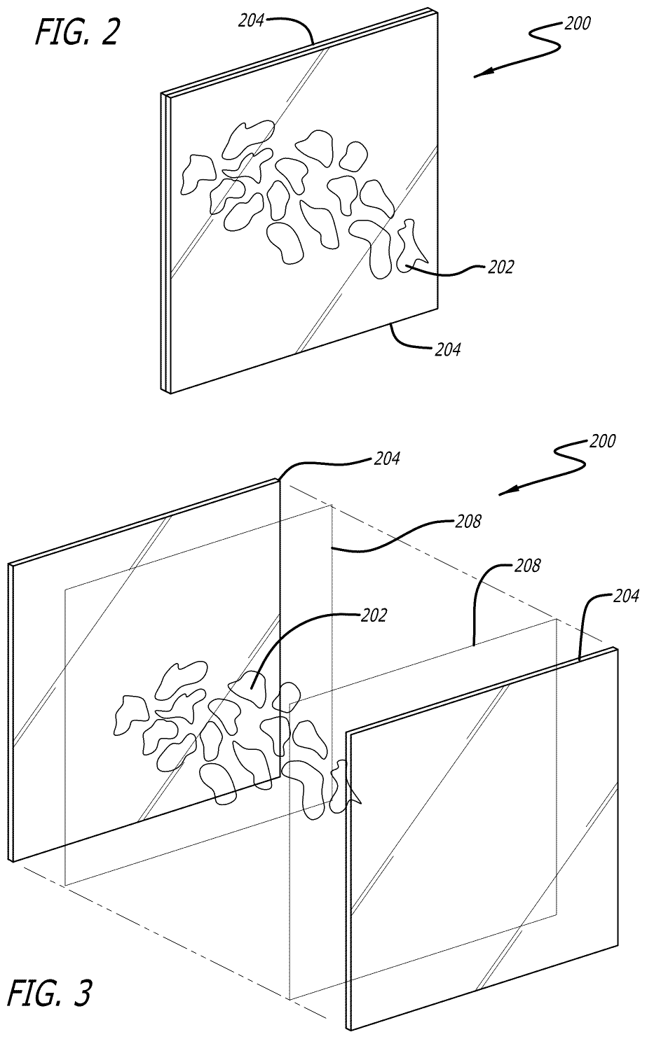

FIG. 2 is an illustration of mica encased between two pieces of glass 200, made in accordance with the method of FIG. 1. Here, the mica 202 can be seen encased in the glass 204.

FIG. 3 is an exploded view of the mica encased glass of FIG. 2. Here, the mica 202 is shown between two pieces of the glass 204 and 206 with interlay film 208.

Again, the above process can be replicated using selenite crystals. A naturally occurring mineral, selenite exhibits a unique chatoyance (or shimmering). Its crystalline structure also refracts light lengthwise. Selenite crystals can be used alone or in combination with mica or other minerals. In all cases, colored panels of mica or selenite crystals (or both) can be created at desired tints, colors and brightness and may include Ulexite, gems, semi-precious gems, agates, and crystals, both man-made or naturally occurring. In all cases, such gems and other semi-precious gems or agates may be crushed or made into tiny crystals or dust and arranged on the mica on the interlay film as one or more layers of mica and interlay.

FIG. 4 is a flow diagram of another example method 400 of the present invention. In this example, the substrate may be a ceramic fiber paper, such as fiber paper sold under the brand name CeraTex® 3170, other fiber board or other panels used in high-temperature foundries and building insulation materials and panels using a similar process to how a painter prepares a canvas with gesso. In this application, powder coating is first applied to the surface of the substrate at step 404.

Optionally, prior to applying the powder coating to the substrate, to achieve various effects, the powder coating may be mixed with a liquid, at step 402, such as water, and then frozen to create a powdered slurry, which can then be shaped. Powder coating is not taught to be exposed to water because it clumps and includes additives to avoid clumping; however, applying shaped pieces of powdered coating in the form of a slurry to the substrate and when baked, achieve a certain final shape, like cookie cutter shapes, bars, pipes, blocks, stars, or other desired molded shapes. In all cases, the powder coating can be applied in different thicknesses to substrate.

In one example, the powder coating, may be a white matte or clear powder, applied either in a textured pattern or smoothly across the surface. The base coat of powder coating affects the appearance of top layers depending upon whether the powder coating is matte or shiny. The application of matte powder has a lesser viscosity when heated, which helps to create a more textured surface effect in the layers above. While the above is discussed as white matter or clear powder, different types of powder coating, as discussed above, can be used in this application without departing from the scope of the invention.

Next, at step 406, the powder coating is baked at approximately 400° F. for approximately 10 minutes, or at least 400° F. for at least 10 minutes. Separated sheets, flakes or books of mica are also prepared for this method at step 408. After baking, while the powder coating is hot (forming a viscous powder), at step 410, flakes, sheets, or books of mica are placed on the hot viscous powder and integrated into the surface. The flakes, books and/or sheets of mica are applied to baked surface so when the powder cools, at step 410, the materials become embedded into it.

Optionally, the baking step 406 may be repeated, and additional mica may be applied between bakes, repeating step 406-410. Additionally, powder coating may also be applied at step 404 between baking steps depending upon the desired effects, repeating steps 406-410. Optionally, mica flakes, sheets and/or books may be silicone-glued during post-production, at step 412. For example, Clear Gorilla® Waterproof Caulk & Seal-100% Silicone Sealant may be used to glue the mica flakes. Gorilla silicone can withstand 350° F. Since the glue is clear, one does not see the glue through the mica when dry.

Further, optionally topcoats can be created by placing, for example, matte powders atop shiny viscose puddles of melted powders to create ribs and valleys, cracklings, spills, or other lacy effects. For topcoats, it is generally preferred to use translucent and transparent topcoat powders to see through underlayers. However, additional colored powders can be introduced into topcoats to create swirls, drips, fanning, and other patterns. Varying heat and time in the oven also allows for different intensities.

Besides providing different visual effects, which can vary based upon type of light and light positioning, mica is inherently a low thermal conductive material or insulator. Accordingly, when used as above and laminated between glass sheets, it allows for efficient retention of heat flow. This effect may be heightened by the introduction of fine mica powder into the process with the application of the mica.

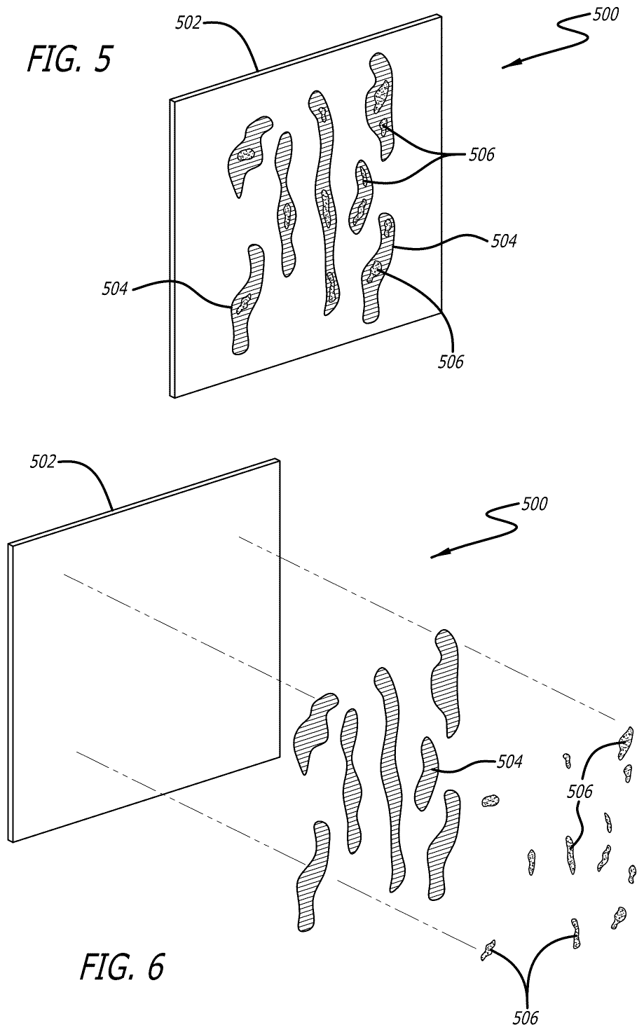

FIG. 5 is an illustration of a mica and powder coating design on a substrate 500 prepared in accordance with the method of FIG. 4. Here ceramic paper 502 is used as the substrate and various layers of powder coating 504 and mica 506 are applied and baked on the ceramic paper 502.

FIG. 6 is an exploded view of one example of the mica and powder coating on a substrate, similar to that shown in FIG. 5. Here ceramic paper 502 is shown with the various layers of powder coating 504 and mica 506.

Using the methods set forth above, the end product is a substrate having mica or other minerals embedded within a powder coating heated on the substrate, where the substrate may be glass, mirror or ceramic paper, to name a few. In another embodiment, the end product is mica or other minerals positioned between two sheets of plastic optical interlay film, which are then positioned between two substrates, such as glass.

As for the powder coatings that may be used in accordance with the methods of the present invention, there are three main categories of powder coatings: thermosets, thermoplastics, and UV curable powder coatings. Most common cross-linkers are solid epoxy resins in so-called hybrid powders in mixing ratios of 50/50, 60/40 and 70/30 (polyester resin/epoxy resin) for indoor applications and triglycidyl isocyanurate (TGIC) in a ratio of 93/7 and β-hydroxy alkylamide (HAA) hardener in 95/5 ratio for outdoor applications. When the powder is baked, it reacts with other chemical groups in the powder to polymerize, improving the performance properties.

There are various types of mica, having varying chemical compositions that can be used with the methods described herein. The chemical composition of muscovite is a hydrated phyllosilicate mineral of aluminum and potassium with the formula KAl₂(AlSi₃O₁₀)(F,OH)₂, or (KF)₂(Al₂O₃)₃(SiO₂)₆(H₂O). Biotite is a common group of phyllosilicate minerals within the mica group, with the approximate chemical formula K(Mg,Fe)₃AlSi₃O₁₀(F,OH)₂. Phlogopite is the magnesium endmember of the biotite solid solution series, with the chemical formula KMg₃AlSi₃O₁₀(F,OH)₂. Kyanite is an aluminum silicate mineral, with the chemical formula Al₂SiO₅. Tinaksite (chemical formula K₂Na(Ca,Mn²⁺)₂TiO[Si₇O₁₈(OH)]).

Ephesite has an ideal chemical formula of NaLiAl2(Al2Si2)O10(OH)2.[6] Ephesite and paragonite are closely related due to their substitution of sodium in place of potassium. The general form of most micas, which can vary such as in the place of ephesite, can be written as W(X,Y)2-3Z4O10(OH,F)2 as observed by many sources. In the case of ephesite the W compound is sodium and the (X,Y) is lithium and aluminium, it also bears two hydroxides as the end members. Paragonite is a mineral, related to muscovite. Its empirical formula is NaA12(AlSi3O10)(OH)2. Annite is a phyllosilicate mineral in the mica family. It has a chemical formula KFe₃²⁺AlSi₃O₁₀(OH)₂. Siderophyllite is a rare member of the mica group of silicate minerals with formula KFe²⁺₂Al(Al₂Si₂)O₁₀(F,OH)₂. Fluorophlogopite has the formula KMg3(AlSi3)O10F2, and Fluorannite KFe²⁺3(Si3Al)O10F. Eastonite is also an individual member of the Biotite group of mica minerals, with a chemical formula of Mg₂Al(AlSi₂O₁₀)(OH)₂. Fuchsite, also known as chrome mica, is a chromium (Cr)-rich variety of the mineral muscovite, belonging to the mica group of phyllosilicate minerals, with the chemical formula K(Al,Cr)₂(AlSi₃O₁₀)(OH)₂. Mariposite has a composition of K(Al,Cr)₂(Al,Si)₄O₁₀(OH)₂.

I claim:

1. A method for creating a decorative display, the method comprising the steps of:
positioning minerals on a substrate; coating the minerals with a powder coating; and
baking the substrate with coated minerals.

2. The method of claim 1 where the minerals are mica and where the method comprises the step of positioning the minerals on the substrate further include separating a sheet of mica into individual panels of mica before positioning the separated mica on the substrate.

3. The method of claim 1 where the minerals are selenite crystals.

4. The method of claim 1 where the substrate is selected from the group comprised of glass, mirror and ceramic paper.

5. The method of claim 1 where the powder coating is a translucent coating.

6. A method for creating a decorative display, the method comprising the steps of:
positioning powder coating on a substrate;
heating the substrate and powder coating to heat and melt the powder coating; and
positioning minerals on the substrate when the powder coating is hot.

7. The method of claim 6 where the powder coating is mixed with water prior to positioning the powder coating on the substrate.

8. The method of claim 6 where the minerals are mica and where the method comprises the step of positioning the minerals on the substrate further includes separating a sheet of mica into individual panels of mica before positioning the separated mica on the substrate.

9. The method of claim 8 where the minerals are selected from the group comprised of selenite crystals, gems, semi-precious gems, metals, broken crystals, and dust.

10. The method of claim 8 where the substrate is selected from the group comprised of ceramic filter paper, cement board, Promatect-H, calcium board, insulation panels or boards, ceramic.

11. The method of claim 6 where the substrate is selected from the group comprised of clear glass, colored glass, mirror, lampshade mica, cast glass, mica panels, and natural mica crystals.

12. The method of claim 8 where the powder coating and substrate are further heated once the mica is positioned on the substrate.

13. The method of claim 8 where all the steps of claim 6 are repeated.

14. A method for creating a decorative display, the method comprising the steps of:
cutting a first and second piece of glass into a desired shape;
positioning a first plastic interlay film on top of the first piece of glass;
arranging mica on the first plastic optical interlay film;
positioning a second plastic optical interlay film on top of the mica;
placing the second piece of glass over the second plastic optical interlay film in a position opposing the mica to create a decorative assembly; and
baking the decorative assembly in a vacuum-sealed heater at various temperatures ranging from 250-325° F. for 10-15 hours.

15. The method of claim 14 further comprising the steps of layering additional layers of glass, interlay film and mica onto the second piece of glass to create a thick assembly of additional layers before baking the decorative assembly in a vacuum-sealed heater at various temperatures ranging from 250-325° F. for 10-15 hours.

16. A glass article having increased thermal resistive qualities to reduce heat transfer, where the glass article comprising at least two pieces of glass having mica positioned between the two pieces of glass, whereby the mica between the glass affects light transfer by dimming the light or reducing intensity, changes the optical characteristics of the glass and acts as an additional insulator for the glass article.

17. The glass article of claim 16 where interlay material is positioned on either or both sides of the mica in between the glass.

18. The glass article of claim 16 where gems, semi-precious gems or agates are crushed or made into tiny crystals or dust particles and positioned with the mica between the two pieces of glass.

19. The glass article of claim 16 where the mica is muscovite mica.
